(19) United States
(12) Patent Application Publication
(10) Pub. No.: US 2019/0130222 A1
(43) Pub. Date: May 2, 2019

(54) MACHINE LEARNING SYSTEM, TRANSPORTATION INFORMATION PROVIDING SYSTEM, AND MACHINE LEARNING METHOD

(71) Applicant: TOYOTA JIDOSHA KABUSHIKI KAISHA, Toyota-shi (JP)

(72) Inventors: Kazuya NISHIMURA, Okazaki-shi (JP); Yoshihiro OE, Kawasaki-shi (JP); Hirofumi KAMIMARU, Fukuoka-shi (JP)

(73) Assignee: TOYOTA JIDOSHA KABUSHIKI KAISHA, Toyota-shi (JP)

(21) Appl. No.: 16/131,929

(22) Filed: Sep. 14, 2018

(30) Foreign Application Priority Data
Oct. 26, 2017 (JP) 2017-207164

(51) Int. Cl. G06K 9/62; G06K 9/00

(52) U.S. Cl. CPC G06K 9/6263; G06K 9/628; G06K 9/00798

(57) ABSTRACT

A machine learning system includes a generation unit configured to generate a classifier that classifies a plurality of image data items into a plurality of categories by performing supervised learning about which of the categories the image data item is to be classified into for each of the image data items, a selection unit configured to select a representative image data item as a representative of the image data items classified in each category among the plurality of image data items, and a deletion unit configured to delete remaining image data items except for the selected image data item.

### INCORPORATION BY REFERENCE

The disclosure of Japanese Patent Application No. 2017-207164 filed on Oct. 26, 2017 including the specification, drawings and abstract is incorporated herein by reference in its entirety.

### BACKGROUND

### 1. Technical Field

The present disclosure relates to a machine learning system, a transportation information providing system, and a machine learning method.

### 2. Description of Related Art

For example, a technique that uses a classifier generated through supervised learning so as to minimize a classification error has been known as a technique that classifies each of a plurality of image data items into any category of a plurality of categories. A support vector machine and a maximum entropy method have been well known as examples of the supervised learning. This kind of machine learning is widely used in the field such as natural language processing or biological information processing in addition to the classification of image data items. In view of such circumstances, Japanese Unexamined Patent Application Publication No. 2015-35118 (JP 2015-35118 A) suggests a technique that accumulates and updates learning data items used in the machine learning so as to reduce the classification error.

### SUMMARY

However, since the amount of accumulated data items becomes enormous as the learning data items used in the machine learning are accumulated, the amount of accumulated data items needs to be reduced in terms of effective use of resources.

The present disclosure provides a machine learning system, a transportation information providing system, and a machine learning method which are capable of further reducing the amount of accumulated data items.

A first aspect of the disclosure relates to a machine learning system including a generation unit configured to generate a classifier that classifies a plurality of image data items into a plurality of categories by performing supervised learning about which of the categories the image data item is to be classified into for each of the image data items, a selection unit configured to select a representative image data item as a representative of the image data items classified in each category among the plurality of image data items, and a deletion unit configured to delete remaining image data items except for the representative image data item.

A second aspect of the disclosure relates to a transportation information providing system including a generation unit configured to generate a classifier that classifies a plurality of image data items indicating a road environment into a plurality of categories by performing supervised learning about which of the categories related to the road environment the image data item is to be classified into for each of the image data items, a selection unit configured to select a representative image data item as a representative of the image data items classified in each category among the plurality of image data items, a deletion unit configured to delete remaining image data items except for the representative image data item, an obtainment unit configured to obtain a road environment image data item indicating a road environment captured by a first vehicle that travels through a predetermined specific point, a determination unit configured to determine which of the categories related to the road environment the image data item indicating the road environment captured by the first vehicle is to be classified into by using the classifier, and a transmission unit configured to transmit the representative image data item as the representative of the determined category and transportation information related to the determined category to a second vehicle that travels toward the specific point.

A third aspect of the disclosure relates to a machine learning method including generating a classifier that classifies a plurality of image data items into a plurality of categories by performing supervised learning about which of the categories the image data item is to be classified for each of the image data items, selecting a representative image data item as a representative of the image data items classified in each category among the plurality of image data items, and deleting remaining image data items except for the representative image data item.

According to the aspects of the disclosure, it is possible to further reduce the amount of accumulated data items by deleting remaining image data items except for an image data item as a representative of each category of a plurality of image data items.

### BRIEF DESCRIPTION OF THE DRAWINGS

Features, advantages, and technical and industrial significance of exemplary embodiments will be described below with reference to the accompanying drawings, in which like numerals denote like elements, and wherein:

FIG. 1 is a hardware configuration diagram showing a schematic configuration of a host computer according to an embodiment;

FIG. 2 is a flowchart showing a flow of a machine learning process according to the embodiment; and

FIG. 3 is a flowchart showing a flow of a transportation information providing process according to the embodiment.

### DETAILED DESCRIPTION OF EMBODIMENTS

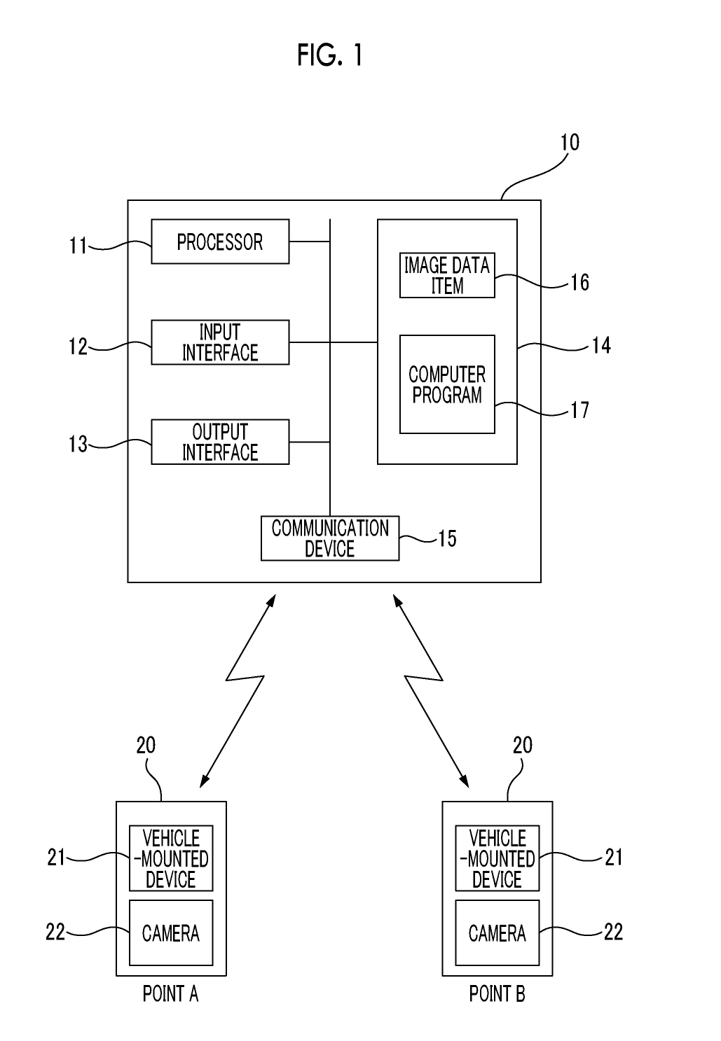

Hereinafter, an embodiment will be described with reference to the drawings. The same numerals denote the same components, and the redundant description thereof will be omitted. FIG. 1 is a hardware configuration diagram showing a schematic configuration of a host computer 10 according to an embodiment. The host computer 10 is a server computer for managing the operation of a plurality of vehicles 20. The host computer 10 obtains positional information of each vehicle 20 from each vehicle 20 via, for example, a mobile communication network, and provides transportation information (for example, information such as a snowy situation and drainage situation of a road) corresponding to a position of the vehicle 20 to the vehicle 20.

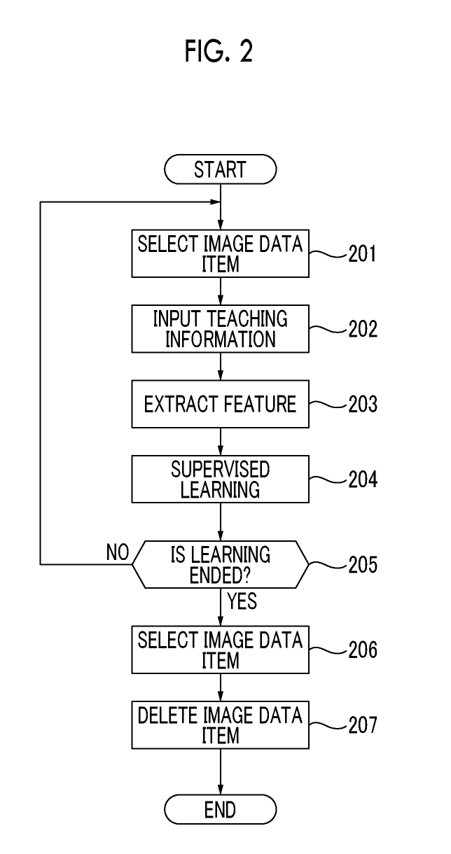

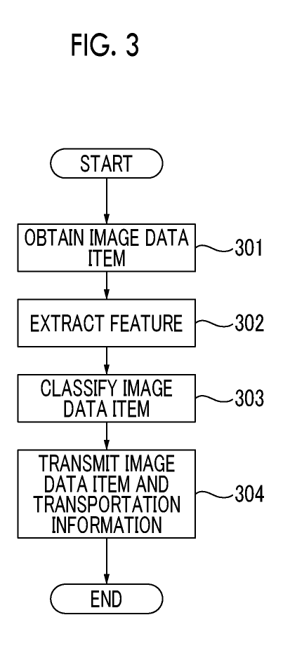

The host computer 10 includes, as hardware resources, a processor 11, an input interface 12, an output interface 13, a storage resource 14, and a communication device 15. A computer program 17 is stored in the storage resource 14. A command for instructing the processor 11 to perform a machine learning process shown in FIG. 2 or a transportation information providing process shown in FIG. 3 is described in the computer program 17. The processor 11 interprets and executes the computer program 17. Thus, the host computer 10 functions as the machine learning system that performs the machine learning process and also functions as the transportation information providing system that performs the transportation information providing process. The details of the machine learning process and the transportation information providing process will be described below. The storage resource 14 is a storage region (logical device) provided by a computer-readable recording medium (physical device). For example, the computer-readable recording medium is a storage device such as a semiconductor memory (volatile memory or nonvolatile memory) or a disk medium. For example, the input interface 12 is a user interface such as a keyboard, a mouse, or a touch panel. For example, the output interface 13 is a user interface such as a display or a printer. For example, the communication device 15 communicates with each vehicle 20 via the mobile communication network.

The vehicle 20 mounts a vehicle-mounted device 21 and a camera 22. The vehicle-mounted device 21 includes a device (for example, Global Positioning System (GPS)) that detects a position of the vehicle 20 and a communication device that communicates with the host computer 10 via the mobile communication network. The camera 22 is a vehicle-mounted digital camera of a recording device called a drive recorder. The vehicle 20 captures a road environment by using the camera 22, and transmits an image data item 16 indicating the captured road environment together with timing information and positional information of the vehicle 20 to the host computer 10 through the vehicle-mounted device 21. The road environment means a weather situation (for example, snowy situation or drainage situation) on the road or near the road. The road environment may be different for each zone. The road environment may be different for each time even in the same zone. A zone in which the identification of the road environment is needed (for example, a zone in which there is an arterial highway, a zone in which a traffic volume is high, or a zone in which a traffic accident occurred in the past) is set in advance. The host computer 10 obtains a plurality of image data items 16 indicating the road environment of the zone set in advance from each vehicle 20, and stores the obtained image data items 16 in the storage resource 14. Each vehicle 20 transmits the positional information of each vehicle to the host computer 10 on a regular basis, and the host computer 10 ascertains the positional information of each vehicle 20.

The flow of the machine learning process will be described with reference to FIG. 2. In step 201, the processor 11 selects one image data item 16 among the image data items 16 stored in the storage resource 14. Preprocessing (for example, processing such as noise removing or normalization of an image size) may be performed on the selected image data item 16 before the process of step 203 is performed.

In step 202, the processor 11 inputs teaching information indicating which of a plurality of categories related to the road environment the image data item 16 selected in step 201 is to be classified into. For example, the teaching information is given in response to an input operation from an operator through the input interface 12. The category related to the road environment is a classification indicating which stage a gradually changeable weather situation on the road or near the road belongs to. For example, a category of “snowy” and a category of “not snowy” may be provided for the road environment related to the snowy situation. For example, a category of “water” and a category of “no water” may be provided for the road environment related to the drainage situation. The number of categories set for each road environment is not limited to two, and may be three or more.

In step 203, the processor 11 extracts a feature (for example, edge, color histogram, directivity feature, or wavelet coefficient) from the image data item 16 selected in step 201. In the process of extracting the feature, the feature needed in the classification of the image data item 16 into each category is calculated as a feature vector.

In step 204, the processor 11 learns a correspondence relationship between the feature of the image data item 16 selected in step 201 and the teaching information input in step 202. The machine learning using the above-described teaching information is called supervised learning. The processor 11 generates a classifier that classifies the image data items 16 into the categories by performing the supervised learning about which of the categories related to the road environment any image data item 16 is to be classified into.

In step 205, the processor 11 determines whether or not the supervised learning is ended for each of the image data items 16. When the supervised learning is not ended for each of the image data items 16 (step 205: NO), the processor 11 repeatedly performs the processes of steps 201 to 204. When the supervised learning is ended for each of the image data items 16 (step 205: YES), the processor 11 performs the process of step 206.

In step 206, the processor 11 selects the image data item 16 as a representative of each category among the image data items 16. For example, the processor 11 selects the image data item 16 having the feature vector having a minimum Euclid distance from a center of a distribution of the feature vectors of each category, as the “image data item 16 as a representative of each category”. Alternatively, the processor 11 may select the image data item 16 having the feature vector having the minimum Euclid distance from an ideal feature vector as the representative of each category, as the “image data item 16 which is a representative of each category”. In this case, the ideal feature vector as the representative of each category is given by an input operation from the operator through the input interface 12. The method of selecting the image data item 16 as the representative of the category is not limited to the above-described two examples. The processor may define which feature vector of the image data item 16 as the representative of the category is, and may select the image data item 16 having the feature vector that satisfies the definition. For example, the processor 11 selects the image data item 16 as the representative of the category of “snowy” and the image data item 16 as the representative of the category of “not snowy” for the road environment related to the snowy situation. For example, the processor 11 selects the image data item 16 as the representative of the category of “water” and the image data item 16 as the representative of the category of “no water” for the road environment related to the drainage situation.

In step 207, the processor 11 deletes the remaining image data items 16 except for the image data item 16 selected in step 206 from the storage resource 14. As described above, since the unneeded image data items 16 except for the image data item 16 as the representative of each category are deleted from the storage resource 14, it is possible to further reduce the amount of accumulated data items.

As described above, the host computer 10 functions as the machine learning system through the cooperation of the hardware resources of the host computer 10 with the computer program 17 for instructing the processor 11 to perform the machine learning process.

The flow of the transportation information providing process will be described with reference to FIG. 3. For the sake of convenience in description, as shown in FIG. 1, the vehicle 20 that travels through a predetermined specific point A is referred to as a first vehicle 20, and the vehicle 20 that travels through a specific point B toward the specific point A is referred to as a second vehicle 20. It is assumed that the specific point A is a predetermined zone in which the identification of the road environment is needed. It is assumed that the classifier is generated in advance through the machine learning process before the transportation information providing process is performed.

In step 301, the processor 11 obtains the image data item 16 indicating the road environment captured by the first vehicle 20 that travels through the predetermined specific point A via the mobile communication network.

In step 302, the processor 11 extracts the feature (for example, edge, color histogram, directivity feature, or wavelet coefficient) from the image data item 16 indicating the road environment captured by the first vehicle 20.

In step 303, the processor 11 determines which of the categories related to the road environment the image data item 16 indicating the road environment captured by the first vehicle 20 is to be classified into by using the classifier based on the feature extracted in step 302. For example, the processor 11 determines whether the image data item 16 indicating the road environment captured by the first vehicle 20 is classified into the category of “snowy” or the category of “not snowy” for the road environment related to the snowy situation. For example, the processor 11 determines whether the image data item 16 indicating the road environment captured by the first vehicle 20 is classified into the category of “water” or the category of “no water” for the road environment related to the drainage situation.

In step 304, the processor 11 transmits the image data item 16 as the representative of the category related to the road environment determined in step 303 and the transportation information related to the category related to the road environment determined in step 303 to the second vehicle 20 that travels through the specific point B toward the specific point A. The transportation information related to the category related to the road environment includes information indicating which stage the gradually changeable weather situation on the road near the specific point A or near this road belongs to. For example, the transportation information may include information for alerting a driver or information related to optimum tires for driving when the snowy situation or the drainage situation is bad, as needed.

As stated above, the host computer 10 functions as the transportation information providing system through the cooperation of the hardware resources of the host computer 10 with the computer program 17 for instructing the processor 11 to perform the machine learning process and the transportation information providing process.

According to the embodiment, it is possible to further reduce the amount of accumulated data items by deleting the remaining image data items 16 except for the image data item 16 as the representative of each category among the image data items 16. For example, in the related art, hundreds of image data items are needed in order to perform the machine learning, and the amount of accumulated data items is large. However, according to the present embodiment, since the minimum amount of image data items 16 can be stored in the storage resource 14, it is possible to further reduce the amount of accumulated data items.

The embodiment may be changed or modified without departing from the gist, and equivalents thereof is in the disclosure. That is, the design of the embodiment may be appropriately changed by those skilled in the art, and the design changes are within the scope of the disclosure and equivalents thereof. The components included in the embodiment may be combined as far as technically possible, and these combinations are within the scope of the disclosure.

What is claimed is:

1. A machine learning system comprising:
a generation unit configured to generate a classifier that classifies a plurality of image data items into a plurality of categories by performing supervised learning about which of the categories the image data item is to be classified into for each of the image data items;
a selection unit configured to select a representative image data item as a representative of the image data items classified in each category among the plurality of image data items; and
a deletion unit configured to delete remaining image data items except for the representative image data item.

2. A transportation information providing system comprising:
a generation unit configured to generate a classifier that classifies a plurality of image data items indicating a road environment into a plurality of categories by performing supervised learning about which of the categories related to the road environment the image data item is to be classified into for each of the image data items;
a selection unit configured to select a representative image data item as a representative of the image data items classified in each category among the plurality of image data items;
a deletion unit configured to delete remaining image data items except for the representative image data item;
an obtainment unit configured to obtain a road environment image data item indicating a road environment captured by a first vehicle that travels through a predetermined specific point;
a determination unit configured to determine which of the categories related to the road environment the image data item indicating the road environment captured by the first vehicle is to be classified into by using the classifier; and
a transmission unit configured to transmit the representative image data item as the representative of the determined category and transportation information related to the determined category to a second vehicle that travels toward the specific point.

3. A machine learning method comprising:
generating a classifier that classifies a plurality of image data items into a plurality of categories by performing supervised learning about which of the categories the image data item is to be classified for each of the image data items;
selecting a representative image data item as a representative of the image data items classified in each category among the plurality of image data items; and
deleting remaining image data items except for the representative image data item.
